(19) United States
(12) Patent Application Publication
(10) Pub. No.: US 2010/0165205 A1
(43) Pub. Date: Jul. 1, 2010

(54) VIDEO SIGNAL SHARPENING APPARATUS, IMAGE PROCESSING APPARATUS, AND VIDEO SIGNAL SHARPENING METHOD

(75) Inventor: Toshiyuki NAMIOKA, Saitama (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/539,428

(22) Filed: Aug. 11, 2009

(30) Foreign Application Priority Data
Dec. 25, 2008 (JP) 2008-331059

(51) Int. Cl. H04N 5/00; H04N 7/12

(52) U.S. Cl. 348/606; 375/240.25; 348/E05.078; 375/E07.027

(57) ABSTRACT

According to one embodiment, a video signal sharpening apparatus includes a video signal sharpening module and a sharpening parameter controller. The video signal sharpening module performs a sharpening process on a decoded video signal based on a sharpening parameter. In the sharpening process, the video signal sharpening module estimates an original pixel value from the decoded video signal and increases the pixels to obtain a high-resolution video signal. The decoded video signal is obtained by a decoder decoding an encoded video signal. The sharpening parameter controller determines the amount of variation in noise and detail component that varies by an I-frame period in a group of pictures (GOP) period of the decoded video signal, and controls the sharpening parameter for the video signal sharpening module.

### CROSS-REFERENCE TO RELATED APPLICATIONS

This application is based upon and claims the benefit of priority from Japanese Patent Application No. 2008-331059, filed Dec. 25, 2008, the entire contents of which are incorporated herein by reference.

### BACKGROUND

1. Field

One embodiment of the invention relates to a video signal sharpening apparatus, an image processing apparatus, and a video signal sharpening method.

2. Description of the Related Art

With the recent widespread of high-resolution televisions and displays, the resolution of video frames becomes higher. As the resolution of a video signal increases, the data volume involved in image processing on the video signal increases. Therefore, there is a need for a technology capable of more efficient image processing. Accordingly, there has been proposed the technology of image processing referred to as super resolution processing (super-resolution enhancement). In the super resolution processing, an original pixel value is estimated from a low-resolution video signal, and the pixels are increased to obtain a high-resolution video signal. Thus, the super resolution processing increases the resolution of image data while maintaining the sharpness thereof. Reference may be had to, for example, Japanese Patent Application Publication (KOKAI) No. 2007-336239.

This technology increases the resolution of standard definition (SD) video such as digital versatile disk (DVD) video and analog video to high resolution video of high definition (HD) quality or the like, thereby enabling the video to be displayed clearly on the wide screen of a high-resolution television or a display.

Besides, in recent years, video encoding and decoding according to MPEG-2, H.264/MPEG-4 AVC have been commonly used. For example, Japanese Patent Application Publication (KOKAI) No. 2000-287212 has proposed a conventional encoding technology. According to the conventional encoding technology, in an MPEG image encoder, a still/moving region is determined with respect to each macroblock between an I frame (picture) in a group of pictures (GOP) being currently processed and an I frame in a GOP prior to the currently processed GOP. If a macroblock is determined to be a still region, the code of an I frame in the prior GOP is read and is encoded as a still region code. In the case of a P frame or a B frame, motion compensation prediction is performed.

Incidentally, an I frame is generated individually from an encoded signal. On the other hand, a P frame is generated based on the difference between an I frame and the P frame in a GOP. Similarly, a B frame is generated based on the difference from an I frame or a P frame before/after the B frame. With this, the difference between an I frame generated individually from an encoded signal and P and B frames becomes smaller in the case of both still image and moving image. Thus, a larger amount of information can be transmitted.

With the conventional encoding technology, however, the P and B frames playback component not contained in the I frame (for example, detail information, etc.), which changes an I-frame period.

Such a change in the I-frame period affects the sharpening process using image processing referred to as super resolution processing and may cause a phenomenon in which noise or detail component (high frequency component) appears or disappears in an output image. This type of image distortion occurs especially in an image with high spatial frequency components. In view of this, there is a need for a technology to suppress the distortion of an MPEG image in the I-frame period as described above.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic block diagram of an image display apparatus according to an embodiment of the invention;

FIG. 2 is an exemplary functional block diagram of an image processor in the embodiment;

FIG. 3 is an exemplary block diagram of a resolution increasing module in the embodiment;

FIG. 4 is an exemplary schematic diagram of a typical temporal array of I, B and P frames in the embodiment;

FIG. 5 is an exemplary graph of an inter-frame difference histogram of an MPEG-2 signal in the embodiment; and

FIG. 6 is an exemplary flowchart of the process of displaying moving image data in the embodiment.

### DETAILED DESCRIPTION

Various embodiments according to the invention will be described hereinafter with reference to the accompanying drawings. In general, according to one embodiment of the invention, a video signal sharpening apparatus comprises a video signal sharpening module and a sharpening parameter controller. The video signal sharpening module is configured to perform a sharpening process on a decoded video signal based on a sharpening parameter. In the sharpening process, the video signal sharpening module estimates an original pixel value from the decoded video signal and increasing the pixels to obtain a high-resolution video signal. The decoded video signal is obtained by a decoder decoding an encoded video signal. The sharpening parameter controller is configured to determine the amount of variation in noise and detail component that varies by an I-frame period in a group of pictures (GOP) period of the decoded video signal, and control the sharpening parameter for the video signal sharpening module.

According to another embodiment of the invention, an image processing apparatus comprises a decoder, a video signal sharpening module, and a sharpening parameter controller. The decoder is configured to decode an encoded video signal and output a decoded video signal. The video signal sharpening module is configured to perform a sharpening process on the decoded video signal based on a sharpening parameter. In the sharpening process, the video signal sharpening module estimates an original pixel value from the decoded video signal and increasing the pixels to obtain a high-resolution video signal. The sharpening parameter controller is configured to determine the amount of variation in noise and detail component that varies by an I-frame period in a group of pictures (GOP) period of the decoded video signal, and control the sharpening parameter for the video signal sharpening module.

According to still another embodiment of the invention, there is provided a video signal sharpening method comprising: a video signal sharpening module performing a sharpening process on a decoded video signal based on a sharpening parameter, the sharpening process including estimating an original pixel value from the decoded video signal and increasing the pixels to obtain a high-resolution video signal, the decoded video signal being obtained by decoding an encoded video signal; and a sharpening parameter controller determining the amount of variation in noise and detail component that varies by an I-frame period in a group of pictures (GOP) period of the decoded video signal, and controlling the sharpening parameter.

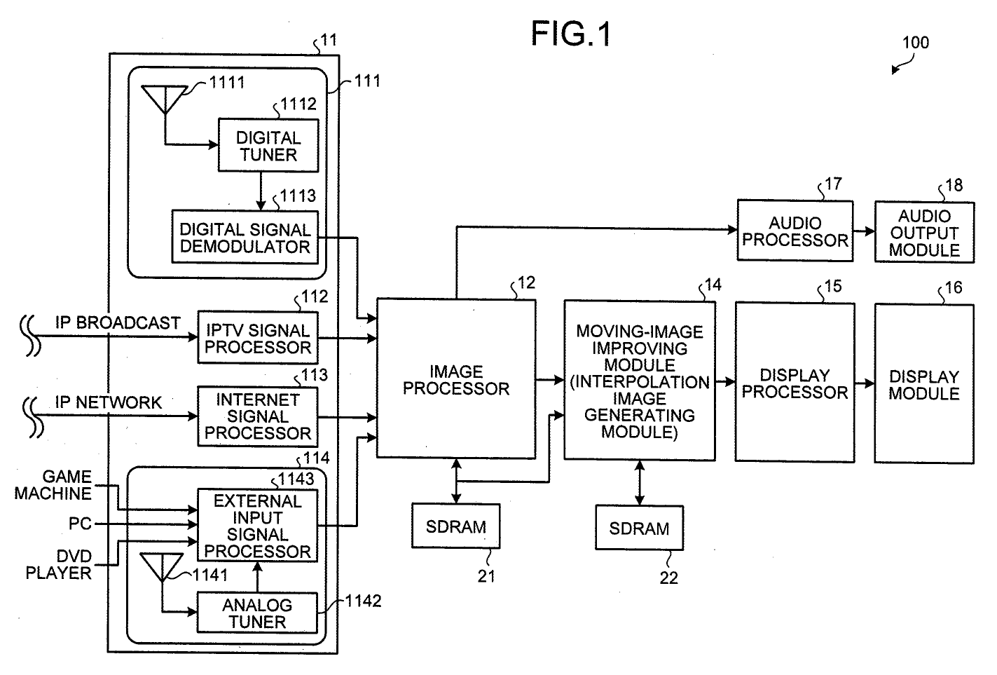

With reference to FIGS. 1 to 6, a description will be given of an embodiment of the invention. FIG. 1 is a schematic block diagram of an image display apparatus 100 according to the embodiment. As illustrated in FIG. 1, the image display apparatus 100 comprises a video signal input module 11, an image processor 12, a moving-image improving module 14, a display processor 15, a display module 16, an audio processor 17, an audio output module 18, and double-data-rate synchronous dynamic random access memories (SDRAMs) 21 and 22. The image processor 12 corresponds to an image processing apparatus.

The video signal input module 11 receives an encoded video signal such as an MPEG signal to be displayed. The video signal input module 11 comprises a digital broadcast receiver 111, an Internet protocol television (IPTV) signal processor 112, an Internet signal processor 113, and an external input module 114. The external input module 114 receives input of an analog signal. The term “video signal” as used herein includes audio signals (audio data) as well as image signals (image data) corresponding to still images and moving images.

The digital broadcast receiver 111 comprises a digital antenna 1111, a digital tuner 1112, and a digital signal demodulator 1113. The digital antenna 1111 receives digital broadcasting such as broadcast satellite (BS) broadcasting, communications satellite (CS) broadcasting, and digital terrestrial broadcasting. The digital tuner 1112 is used to select a digital broadcast channel. The digital signal demodulator 1113 demodulates a digital broadcast signal and outputs it to the image processor 12 as a digital video signal.

The IPTV signal processor 112 receives IP broadcasting transmitted over a dedicated IP network, and outputs it to the image processor 12 as a digital video signal.

The Internet signal processor 113 receives data (a still image, a moving image, etc.) transmitted through an IP network such as the Internet, and outputs it to the image processor 12 as a digital video signal.

The external input module 114 comprises an analog antenna 1141, an analog tuner 1142, and an external input signal processor 1143. The analog antenna 1141 receives analog broadcasting. The analog tuner 1142 is used to select an analog broadcast channel. The external input signal processor 1143 performs signal processing such as analog-to-digital (A/D) conversion on an analog signal, and outputs it to the image processor 12 as a digital video signal. The external input signal processor 1143 is provided with a terminal (not illustrated) for connection to an external device such as a game machine, a personal computer (PC), a digital versatile disk (DVD) player. The external input signal processor 1143 performs the signal processing also on an analog signal received from an external device through the terminal.

The image processor 12 performs various types of processing on an encoded video signal, such as an MPEG signal, received by the video signal input module 11. More specifically, the image processor 12 performs MPEG decoding on the video signal, separates the video signal into image data and audio data, scales the image data, and increases the resolution of the image data.

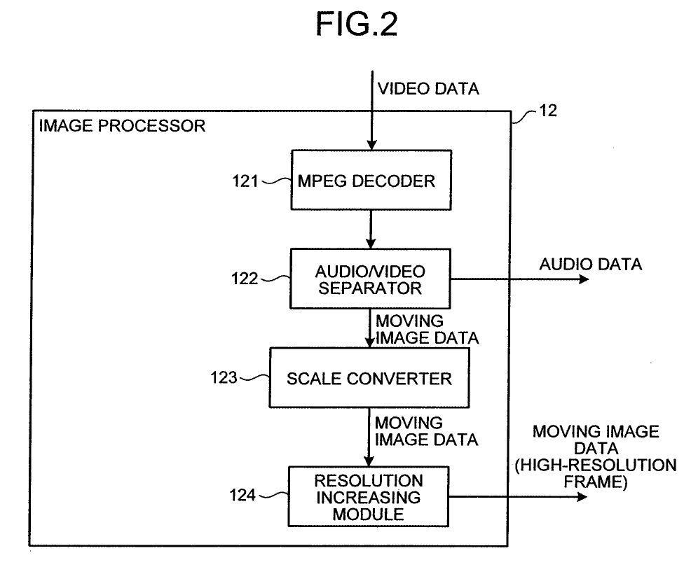

FIG. 2 is a functional block diagram of the image processor 12. As illustrated in FIG. 2, the image processor 12 comprises an MPEG decoder 121, an audio/video separator 122, a scale converter 123, and a resolution increasing module 124. The resolution increasing module 124 corresponds to a video signal sharpening apparatus.

The MPEG decoder 121 decodes MPEG video data received by the video signal input module 11. The audio/video separator 122 separates the decoded video data into image data (moving image data) and audio data. The audio/video separator 122 then outputs the audio data to the audio processor 17 and the image data (moving image data) to the scale converter 123.

The scale converter 123 performs scale conversion of each frame of the input moving image data to obtain image data at a frame size of 1440×1080 (1440 horizontal pixels and 1080 vertical lines). For example, in the case of moving image data input from a DVD player or the like, the scale converter 123 converts each frame of the input moving image data from the SD resolution (720×480) to a resolution of 1440×1080. Upon receipt of moving image data at a frame size of 1440×1080 (1440 horizontal pixels and 1080 vertical lines), the scale converter 123 does not perform the scale conversion.

The scale conversion performed by the scale converter 123 is different from super resolution conversion, which will be described later, in that an image of the SD resolution of 720×480 or an image of a resolution of 1280×720 is simply converted to an image of a resolution of 1440×1080, and is achieved by pixel interpolation using a conventional linear filter.

The scale converter 123 then outputs the moving image data to the resolution increasing module 124 frame by frame.

The resolution increasing module 124 receives the moving image data having a resolution of 1440×1080 pixels output from the scale converter 123 frame by frame. The resolution increasing module 124 performs super resolution conversion, which will be described later, on the moving image data to generate high-resolution moving image data at the HD frame size of 1920×1080 pixels. For the sake of description, a resolution of 1440×1080 pixels will be hereinafter referred to as “intermediate resolution”.

The moving image data input to the resolution increasing module 124 consists of a plurality of frames at the intermediate resolution of 1440×1080 pixels. The moving image data has a frame rate of 60 frames per second (fps) so that 60 intermediate resolution frames thereof are displayed per second.

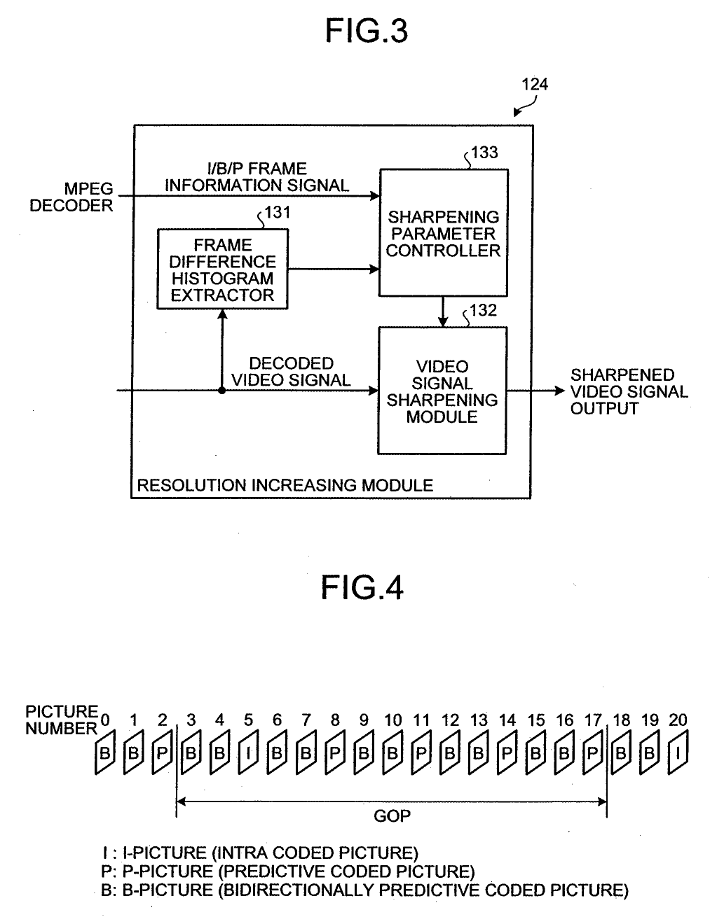

FIG. 3 is a block diagram of the resolution increasing module 124. As illustrated in FIG. 3, the resolution increasing module 124 comprises a frame difference histogram extractor 131, a video signal sharpening module 132, and a sharpening parameter controller 133.

As can be seen from FIG. 3, the MPEG decoder 121 outputs a signal (I/B/P frame information signal) that identifies an intraframe, a bidirectional frame, and a predicted frame, i.e., I, B, and P frames, in a GOP period to the sharpening parameter controller 133. FIG. 4 is a schematic diagram of a typical temporal array of I, B and P frames. The term “group of pictures (GOP)” refers to the minimum structure that constitutes a moving image defined by MPEG. The GOP is comprised of three types of frames, i.e., I, B, and P frames. The use of the P frame that adopts unidirectional motion compensation prediction and the B frame that adopts bidirectional prediction with respect to a single I frame enables the edition and random access. In the example of FIG. 4, an I frame with a picture number 5 is individually generated from an encoded signal. Meanwhile, P frames with picture numbers 8, 11, 14, and 17 are generated based on difference information from frames with picture numbers 5, 8, 11, and 14, respectively. Besides, B frames with picture numbers 3-4, 6-7, 9-10, and 12-13 are generated based on difference information from an I frame or a P frame before/after the B frames.

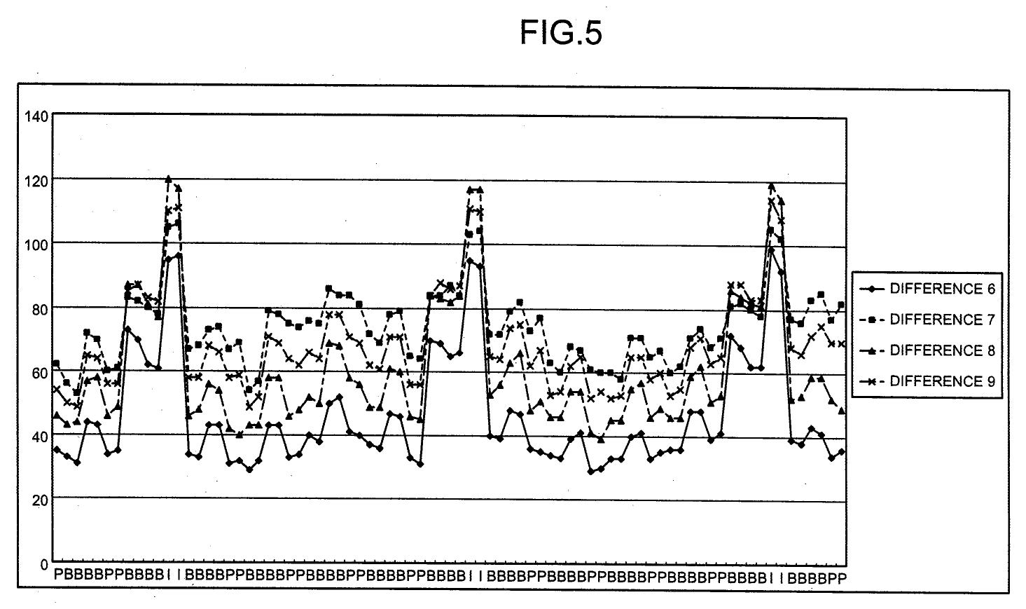

The frame difference histogram extractor 131 counts the difference between frames of an image and extracts difference histogram of low amplitude between the frames. FIG. 5 illustrates an example of an inter-frame difference histogram of an MPEG-2 signal. In the example of FIG. 5, an interlace video signal is an 8-bit signal. Accordingly, two points (two fields) indicate a frame of I, B, and P frames. The X axis represents I, B, and P frames, while the Y axis represents the count number. A line chart illustrated in FIG. 5 gives, by way of example, four low amplitude differences, i.e., differences 6, 7, 8, and 9. As can be seen from FIG. 5, the I frames have more difference histograms than the others and vary periodically. The amount of variation can be estimated by detecting the largest variation in the four low amplitude differences 6, 7, 8, and 9. Such a variation in low amplitude differences corresponds to a variation in noise/detail component (high frequency component) that varies by an I-frame period.

The video signal sharpening module 132 performs image processing for resolution enhancement (hereinafter, “super resolution conversion (sharpening process)”) on an input intermediate resolution frame to increase the resolution thereof, thereby generating a frame of high-resolution moving image data in the HD size (hereinafter, “high resolution frame”).

The term “super resolution conversion” as used herein refers to sharpening process, in which, from an image signal with low resolution or intermediate resolution, i.e., first resolution (a low-resolution frame or an intermediate resolution frame), an original pixel value is estimated to increase the pixels and thus to restore a sharpened video signal with high resolution, i.e., second resolution (a high resolution frame).

The term “original pixel value” as used herein refers to the value of each pixel of an image signal obtained by, for example, photographing the same object as that of an image with low resolution (first resolution) with a camera having high-resolution pixels and capable of capturing an image with high resolution (second resolution).

Besides, “original pixel value is estimated to increase the pixels” means to obtain the characteristics of images to find a correlated image, and estimate an original pixel value from neighboring images (in the same frame or between frames) using the correlated image to increase the pixels.

The super resolution conversion may be performed using known or commonly used technologies as disclosed in, for example, Japanese Patent Application Publication (KOKAI) Nos. 2007-310837, 2008-98803, and 2000-188680. In the embodiment, the super resolution conversion uses a technology of, for example, restoring an image with frequency components above the Nyquist frequency determined by the sampling rate of an input image.

If employing the super resolution conversion disclosed in Japanese Patent Application Publication (KOKAI) No. 2007-310837, the video signal sharpening module 132 sets a target pixel in each of a plurality of intermediate resolution frames, and sets a target image area so that it contains the target pixel. The video signal sharpening module 132 selects a plurality of correspondent points that correspond to a plurality of target image areas closest to a variation pattern of the pixel value in the target image area from a reference frame. The video signal sharpening module 132 sets a sample value of luminance of a correspondent point to the pixel value of a corresponding target pixel. The video signal sharpening module 132 calculates a pixel value for a high resolution frame having more pixels than the reference frame and corresponding to the reference frame based on the size of a plurality of sample values and layout of the correspondent points. Thus, the video signal sharpening module 132 estimates an original pixel value from an intermediate frame, and increases the pixels to restore a high resolution frame.

If employing the super resolution conversion using self-congruency position search in the same frame image disclosed in Japanese Patent Application Publication (KOKAI) No. 2008-98803, the video signal sharpening module 132 calculates a first pixel position with the smallest error, i.e., a first error, by comparing errors of respective pixels in a search area of an intermediate resolution frame. The video signal sharpening module 132 calculates a position with the smallest error in the search area with decimal precision based on the first pixel position and the first error, and a second pixel position around a first pixel and a second error thereof. The video signal sharpening module 132 calculates a decimal-precision vector that has its end point at the position with the smallest error and its start point at a pixel of interest. The video signal sharpening module 132 calculates an extrapolation vector of the decimal-precision vector that has its end point at a pixel on a screen which is not in the search area based on the decimal-precision vector. The video signal sharpening module 132 calculates a pixel value for a high resolution image having more pixels than image data based on a pixel value obtained from the image data, the decimal-precision vector, and the extrapolation vector. In this manner, the video signal sharpening module 132 estimates an original pixel value from an intermediate resolution frame, and increases the pixels to restore a high resolution frame.

The video signal sharpening module 132 may employ the super resolution conversion disclosed in Japanese Patent Application Publication (KOKAI) No. 2000-188680 using mapping between a plurality of frames.

The above technologies of the super resolution conversion (sharpening process) are cited by way of example and not by way of limitation. The video signal sharpening module 132 may employ various other technologies in which an original pixel value is estimated from a low or intermediate resolution image signal to increase the pixels to thereby obtain a high-resolution image signal.

The video signal sharpening module 132 performs the super resolution conversion (sharpening process) using a sharpening parameter set by the sharpening parameter controller 133.

The sharpening parameter controller 133 determines a fluctuation pattern (periodic variation) and the amount of fluctuation (variation) in a GOP period based on the I/B/P frame information signal output from the MPEG decoder 121 and the frame difference histogram extracted by the frame difference histogram extractor 131. Thus, the sharpening parameter controller 133 controls the sharpening parameter.

A description will now be given of an example of how the sharpening parameter controller 133 controls the sharpening parameter. In an example of sharpening using the super resolution conversion, a slight blur of image component is estimated to restore a fine image, and a parameter is retained to specify a level or a degree at which the image is to be restored. In an MPEG signal with a large periodic variation, minute image component (high frequency component), which does not appear in an I frame, may appear in B and P frames. Further, MPEG noise such as mosquito noise may periodically vary. In such a case, if the function of estimating a slight blur of image component to restore a fine image is used, it results in emphasizing the periodic variation in noise/detail component (high frequency component). Therefore, the sharpening parameter controller 133 of the embodiment determines the amount of fluctuation (variation) in low amplitude difference (noise/detail component) that varies by an I-frame period, i.e., a fluctuation pattern (periodic variation) in a GOP period, and controls the sharpening parameter of the video signal sharpening module 132 for an I frame in which noise component or high frequency component appears. In this manner, the sharpening parameter controller 133 sets a low level to restore an image based on the noise component or the high frequency component. Thus, it is possible to suppress image distortion that occurs in an I-frame period of the GOP period (i.e., emphasis of periodic variation in noise/detail component), and thereby to prevent a sharpened video signal obtained by the super resolution conversion from degrading.

Referring back to FIG. 1, the moving-image improving module 14 is an interpolation image generating module that generates an interpolation frame from image data consisting of a plurality of high resolution frames received from the image processor 12 to increase the frame rate of the image data. In the embodiment, to change the frame rate, the moving-image improving module 14 performs motion compensation based on two high resolution frames and generates an interpolation frame.

More specifically, the moving-image improving module 14 receives a high resolution frame subjected to the super resolution conversion output from the image processor 12. Meanwhile, the moving-image improving module 14 reads an immediately preceding frame, i.e., a high resolution frame subjected to the super resolution conversion one frame prior to the high resolution frame received from the image processor 12, out of the SDRAM 21. The moving-image improving module 14 calculates a motion vector from the two high resolution frames to perform motion compensation, and, based on the result, obtains an interpolation frame to be interpolated between the two high resolution frames. Such interpolation frame generation may be performed using known or commonly used technologies as disclosed in, for example, Japanese Patent Application Publication (KOKAI) No. 2008-35404. This technology of interpolation frame generation is cited by way of example and not by way of limitation. The moving-image improving module 14 may employ various other technologies for generating an interpolation frame.

In the embodiment, the moving-image improving module 14 converts the frame rate of moving image data subjected to the super resolution conversion by the image processor 12 from 60 fps to 120 fps by interpolating an interpolation frame between each pair of frames so that 120 frames are displayed per second.

The SDRAM 22 is a memory that temporarily stores a frame upon generation of an interpolation frame.

The frame rate converted by the moving-image improving module 14 is cited above by way of example and not of limitation. In addition, although an example is described in which one interpolation frame is interpolated between each pair of high resolution frames, a plurality of interpolation frames may be interpolated between each pair of high resolution frames.

Referring back to FIG. 1, the display processor 15 comprises a display driver and controls display of moving image data received from the moving-image improving module 14 on the display module 16. The display module 16 comprises a display device such as a liquid crystal display (LCD) panel or a surface-conduction electron-emitter display (SED) panel. The display module 16 displays an image according to an image signal on the screen under the control of the display processor 15.

The audio processor 17 converts a digital audio signal received from the image processor 12 into an analog audio signal in a format reproducible by the audio output module 18. The audio processor 17 then outputs the analog audio signal to the audio output module 18. The audio output module 18 may be a speaker or the like. Upon receipt of the analog audio signal from the audio processor 17, the audio output module 18 outputs it as audio.

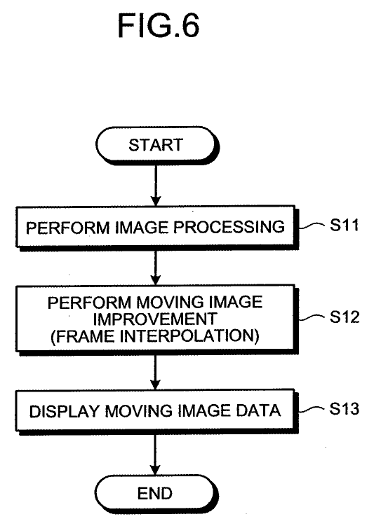

A description will be given of resolution enhancement and moving image improvement performed on moving image data as described above. FIG. 6 is a flowchart of a process of displaying the moving image data according to the embodiment.

The video signal input module 11 performs predetermined processing such as digital demodulation on a video signal of digital broadcasting, etc. received by the digital broadcast receiver 111 or the like. The video signal is then input to the image processor 12. Incidentally, other signals than those of digital broadcasting are also input to the image processor 12.

Upon receipt of the video signal, the image processor 12 performs image processing such as format conversion and decoding of the video signal, separates the video signal into image data and audio data, and super resolution conversion on the video signal (S11).

After the image processing such as the super resolution conversion is performed on the video signal, the moving-image improving module 14 performs moving image improvement on the moving image data consisting of high resolution frames. More specifically, the moving-image improving module 14 generates interpolation frames and interpolates them between the high resolution frames, thereby changing the frame rate of the moving image data to 120 fps (S12).

Then, the moving-image improving module 14 outputs the moving image data, the frame rate of which has been changed, to the display processor 15. The display processor 15 receives the moving image data, and displays it on the display module 16 (S13). With this, the display module 16 displays the high-resolution moving image data in HD size with smooth motion.

As described above, according to the embodiment, a sharpening parameter is controlled based on the amount of fluctuation (variation) in noise/detail component that varies by an I-frame period in a GOP period of a decoded video signal obtained by a decoder that decodes an encoded video signal. Using the sharpening parameter, the sharpening process is performed by estimating an original pixel value from the decoded video signal and increasing the pixels to obtain a high-resolution video signal. Thus, it is possible to suppress image distortion that occurs in an I-frame period of a GOP period, and thereby to prevent a sharpened video signal obtained by the super resolution conversion from degrading.

In the embodiment described above, the sharpening parameter controller 133 receives an I/B/P frame information signal output from the MPEG decoder 121 as well as a frame difference histogram extracted by the frame difference histogram extractor 131 to control the sharpening parameter for the video signal sharpening module 132. However, the sharpening parameter controller 133 may control the sharpening parameter without using the I/B/P frame information signal. In this case, for example, the sharpening parameter controller 133 estimates the pattern of I, B, and P frames from a signal of the frame difference histogram, and controls the sharpening parameter.

While an image processing apparatus of an embodiment is described above as the image display apparatus 100 such as a digital TV comprising the display processor 15, the display module 16, the audio processor 17, and the audio output module 18, it may not necessarily be provided with them. In other words, the image processing apparatus may be, for example, a tuner or a set-top box without having those modules.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal sharpening apparatus comprising:
a video signal sharpening module configured to perform a sharpening process on a decoded video signal based on a sharpening parameter, the video signal sharpening module estimating an original pixel value from the decoded video signal and increasing pixels to obtain a high-resolution video signal in the sharpening process, the decoded video signal being obtained by a decoder decoding an encoded video signal; and
a sharpening parameter controller configured to determine an amount of variation in noise and detail component that varies by an intraframe period in a group of pictures (GOP) period of the decoded video signal, and control the sharpening parameter for the video signal sharpening module.

2. The video signal sharpening apparatus of claim 1, further comprising a frame difference histogram extractor configured to count image difference between frames of the decoded video signal and extract difference histogram of low amplitude between the frames, wherein
the sharpening parameter controller is configured to determine the amount of variation in noise and detail component that varies by the intraframe period in the GOP period of the decoded video signal based on an I, B, and P frame information signal output from the decoder and the difference histogram of low amplitude between the frames extracted by the frame difference histogram extractor.

3. The video signal sharpening apparatus of claim 1, further comprising a frame difference histogram extractor configured to count image difference between frames of the decoded video signal and extract difference histogram of low amplitude between the frames, wherein
the sharpening parameter controller is configured to determine the amount of variation in noise and detail component that varies by the intraframe period in the GOP period of the decoded video signal based on the difference histogram of low amplitude between the frames extracted by the frame difference histogram extractor.

4. The video signal sharpening apparatus of claim 1, wherein the sharpening parameter controller is configured to determine the amount of variation in noise and detail component that varies by the intraframe period in the GOP period of the decoded video signal based on an I, B, and P frame information signal output from the decoder.

5. An image processing apparatus comprising:
a decoder configured to decode an encoded video signal and output a decoded video signal;
a video signal sharpening module configured to perform a sharpening process on the decoded video signal based on a sharpening parameter, the video signal sharpening module estimating an original pixel value from the decoded video signal and increasing pixels to obtain a high-resolution video signal in the sharpening process; and
a sharpening parameter controller configured to determine an amount of variation in noise and detail component that varies by an intraframe period in a group of pictures (GOP) period of the decoded video signal, and control the sharpening parameter for the video signal sharpening module.

6. The image processing apparatus of claim 5, further comprising a frame difference histogram extractor configured to count image difference between frames of the decoded video signal and extract difference histogram of low amplitude between the frames, wherein
the sharpening parameter controller is configured to determine the amount of variation in noise and detail component that varies by the intraframe period in the GOP period of the decoded video signal based on an I, B, and P frame information signal output from the decoder and the difference histogram of low amplitude between the frames extracted by the frame difference histogram extractor.

7. The image processing apparatus of claim 5, further comprising a frame difference histogram extractor configured to count image difference between frames of the decoded video signal and extract difference histogram of low amplitude between the frames, wherein
the sharpening parameter controller is configured to determine the amount of variation in noise and detail component that varies by the intraframe period in the GOP period of the decoded video signal based on the difference histogram of low amplitude between the frames extracted by the frame difference histogram extractor.

8. The image processing apparatus of claim 5, wherein the sharpening parameter controller is configured to determine the amount of variation in noise and detail component that varies by the intraframe period in the GOP period of the decoded video signal based on an I, B, and P frame information signal output from the decoder.

9. A video signal sharpening method comprising:
a video signal sharpening module performing a sharpening process on a decoded video signal based on a sharpening parameter, the sharpening process including estimating an original pixel value from the decoded video signal and increasing pixels to obtain a high-resolution video signal, the decoded video signal being obtained by decoding an encoded video signal; and
a sharpening parameter controller determining an amount of variation in noise and detail component that varies by an intraframe period in a group of pictures (GOP) period of the decoded video signal, and controlling the sharpening parameter.
